(19) United States
(12) Patent Application Publication
(10) Pub. No.: US 2004/0194032 A1
(43) Pub. Date: Sep. 30, 2004

(54) Systems and methods for attribute-based product document profiling

(76) Inventors: Peiya Liu, East Brunswick, NJ (US); Liang H. Hsu, West Windsor, NJ (US)

Correspondence Address: Siemens Corporation, Intellectual Property Department, 170 Wood Avenue South, Iselin, NJ, 08830, US

(21) Appl. No.: 10/403,116

(22) Filed: Mar. 31, 2003

(51) Int. Cl. G06F 17/21

(52) U.S. Cl. 715/530

(57) ABSTRACT

A product document profiling system and method for automatically generating product-specific documents from a master document. A product document profiling system comprises a document variant calculator module and a document selector module. The document variant calculator module processes product specifications for specific products and component definitions for components of a master document, and generates document variants for the specific products. Each document variant comprises a set of component identifiers that identify components of the master document which are associated with a given specific product. The document selector module processes the master document and the document variants to automatically generate a plurality of document instances of the master document. Each document instance comprises a unique document profile for a specific product.

### TECHNICAL FIELD

The present invention generally relates systems and methods for profiling product documents. In particular, the invention relates to systems and methods for automated profiling of product documents for a family of related products based on prepositional logic of product attributes and document component logic definitions.

### BACKGROUND

Document processing is important for a variety of applications such as office automation, creation of electronic manuals, online documentation and annotation etc. For example, when developing a family of related products, it is advantageous and desirable to generate document profiles for related products to differentiate information associated with such related products. Indeed, methods that enable production of significant amounts of product documents in an effective way is important in may industries, such as documentation for complex machinery in heavy industries. By way of further example, a family of related software products that are based on the same core code may be similar, but is desirable to profile information for a given product based on the specific information associated therewith.

Conventional authoring processes for document profiling include manually creating documents using proprietary desktop authoring software, such as MSWord, Interleaf, etc. Conventional single document authoring schemes have disadvantages such as longer authoring times, being error prone, having scalability problems, etc. Particularly, such schemes are not suitable for creating, e.g., a technical product manual for family of related product documents. Typically, technical product manuals for family of related products are variations of core technical information about shared product components. With traditional authoring schemes, authors often use “copy-and-paste” methods from other similar product manuals and then perform small modifications for creating variations of similar information.

Other conventional profiling schemes include personalization techniques based on user profiles in e-business applications. However, these techniques cannot be used for product document profiling because they are not suitable for application of structured information based on product characteristics and properties. The user profiles are based on users' preferences and past purchasing or information look-up habits.

With the development of open standards such as SGML (Standard Generalized Markup Language) and XML (extensible Markup Language), however, document authoring using such non-proprietary formats is leading to more efficient and effective methods for document processing. As is known in the art, SGML is an international standard for the definition of device-independent, system independent methods of representing texts in electronic form (see SGML ISO 8879:1986 Text and Office System—Standard Generalized Markup Language, Geneva, 1986). SGML provides a standard for defining descriptions of the structure of different types of electronic documents.

Further, XML is an extensible text format standard derived from SGML, which has been developed for use with large-scale electronic publishing and network exchange of various types of data, for example. XML allows authors and providers to design their own document markup (see XML Extensible Markup Language (XML) 1.0 (Second Edition) W3C Recommendation 6 Oct. 2000).

Accordingly, it would be highly desirable to develop an automated system and method based on SGML/XML for profiling of product documents for a family of related products, which overcomes the disadvantages associated with conventional document processing schemes.

### SUMMARY OF THE INVENTION

The present invention relates to systems and methods for automated profiling of product documents for a family of related products based on prepositional logic of product attributes, which comprise logic assertions of physical characteristics of products and their components, as well as document component logic definitions. Preferably, systems and methods according to the invention generate a family of related product documents automatically and systematically from a SGML/XML component-based master document. The component-based master document can be shared and reused for a family of related product lines.

In one aspect of the invention, a method for processing electronic documents comprises generating a master document having a plurality of components, generating a product specification for a specific product, wherein the product specification is defined by one or more product attributes, generating component definitions for components of the master document, wherein components of the master document are defined based on the product attributes, and automatically generating a document profile for the specific product using components of the master document based on the component definitions and the product specification.

Preferably, the master document is authored using SGML (standard generalized markup language) or an extension thereof. The document profile comprises a document instance of the master document.

In another aspect of the invention, the step of automatically generating a document profile comprises evaluating the product attributes and the component definitions to generate an intermediate result comprising a set of components from the master document that are associated with the specific product, and selecting components of the master document based on the intermediate result to create the document profile for the specific product.

In yet another aspect of the invention, the components of the master document are identified by unique component numbers. The component definitions for the components of the master document are defined by Boolean formulas of the product attributes. The Boolean formulas of the component definitions are evaluated to determine which component numbers of the master document are associated with the specific product.

In yet another aspect, a product specific identification number is specified for the specific product and the product specific identification number is included in the document profile. Preferably, the product-specific number comprises a KKS number.

In another aspect of the invention, a product document profiling system for automatically generating product-specific documents from a master document comprises a document variant calculator module and a document selector module. The document variant calculator module processes product specifications for specific products and component definitions for components of a master document, and generates document variants for the specific products. Each document variant comprises a set of component identifiers that identify components of the master document which are associated with a given specific product. The document selector module processes the master document and the document variants to automatically generate a plurality of document instances of the master document. Each document instance comprises a unique document profile for a specific product. Preferably, the product specifications comprise logical assertions of product attributes of the specific products, and the components of the master document are defined by Boolean formulations of the product attributes. Further, the component identifiers comprise textblock numbers.

In yet another aspect of the invention, the document selector module processes product specific identification numbers for the specific products and instantiates the product specific identification numbers in the document profiles. Preferably, the product-specific numbers comprise KKS numbers.

These and other aspects, features and advantages of the present invention will be described or become apparent from the following detailed description of the preferred embodiments, which is to be read in connection with the accompanying drawings.

### BRIEF DESCRIPTION OF THE DRAWINGS

FIG. 1 is a diagram illustrating a system for providing automatic document profiling according to an embodiment of the invention.

FIGS. 2a and 2b are exemplary diagrams illustrating a component-based master document according to one aspect of the invention, which is used to create product-specific documents, wherein FIG. 2a illustrates a tree-structure of an exemplary master document and FIG. 2b illustrates an SGML/XML instantiation of the exemplary master document based on the tree structure of FIG. 2a.

FIG. 2c is an exemplary diagram illustrating logic specifications for product attributes for two exemplary products, ProductA and ProductB, and logic specifications for document components of the master document shown in FIG. 2b.

FIG. 3 is a flow diagram illustrating a method for determining document variants according to one aspect of the invention.

FIG. 4 is a flow diagram illustrating method for selecting document components from a master document to generate document profiles, according to one aspect of the invention.

FIGS. 5a and 5b are an exemplary diagrams illustrating a document profile for ProductA derived from the master document of FIG. 2b using the exemplary specifications and the master document components shown in FIG. 2c, wherein FIG. 5a illustrates a tree-structure of the exemplary document profile for ProductA and FIG. 5b illustrates an SGML/XML instantiation of the document profile for ProductA based on the tree structure of FIG. 5a.

FIGS. 6a and 6b are an exemplary diagrams illustrating a document profile for ProductB derived from the master document of FIG. 2b using the exemplary specifications and the master document components shown in FIG. 2c, wherein FIG. 6a illustrates a tree-structure of the exemplary document profile for ProductB and FIG. 6b illustrates an SGML/XML instantiation of the document profile for ProductB based on the tree structure of FIG. 6a.

### DETAILED DESCRIPTION OF PREFERRED EMBODIMENTS

The present invention generally relates systems and methods for processing electronic documents. In particular, the invention relates to systems and methods for automated profiling of product documents for a family of related products based on prepositional logic of product attributes, which comprise logic assertions of physical characteristics of products and their components, as well as document component logic definitions.

Preferably, systems and methods according to the invention enable automatic and systematic generation of a family of related product documents from a SGML/XML component-based master product document. Advantageously, a component-based master document according to the invention can be shared and reused for family of related product lines.

It is to be understood that the systems and methods described herein in accordance with the present invention may be implemented in various forms of hardware, software, firmware, special purpose processors, or a combination thereof. Preferably, the present invention is implemented in software as an application comprising program instructions that are tangibly embodied on one or more program storage devices (e.g., magnetic floppy disk, RAM, CD Rom, DVD, ROM and flash memory), and executable by any device or machine comprising suitable architecture.

It is to be further understood that because the constituent system modules and method steps depicted in the accompanying Figures are preferably implemented in software, the actual connections between the system components (or the flow of the process steps) may differ depending upon the manner in which the application is programmed. Given the teachings herein, one of ordinary skill in the related art will be able to contemplate these and similar implementations or configurations of the present invention.

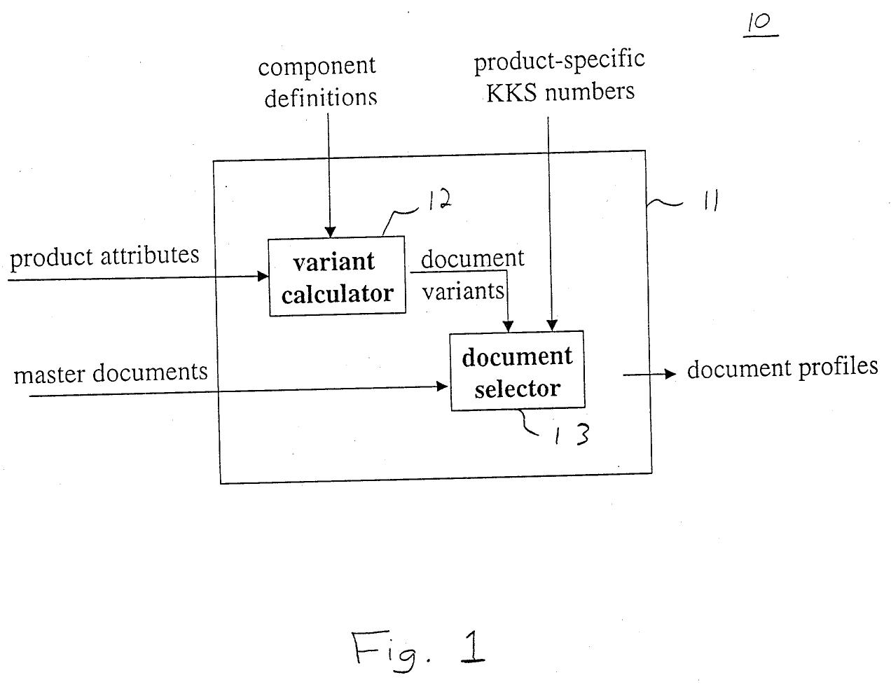

Referring now to FIG. 1, a block diagram illustrates a system for providing automatic product document profiling according to an embodiment of the invention. It is to be appreciated that FIG. 1 further depicts a high-level flow diagram of an automated method for product document profiling according to one aspect of the invention. In FIG. 1, a product document profiling system (10) comprises a product document profiling module (11) which is preferably designed for generating product-specific documents on-the-fly from component-based master documents. In a preferred embodiment, the product document profiling module (11) receives as input, product attributes, component-based master documents, component definitions and product-specific KKS numbers. The product document profiling module (11) processes the input data to automatically create document profiles (or product-specific documents) that are derived from a component-based master document based on, and in conformance with, input specifications. Preferably, the component-based master documents and document profiles are structured text files that are based on the SGML/XML standard.

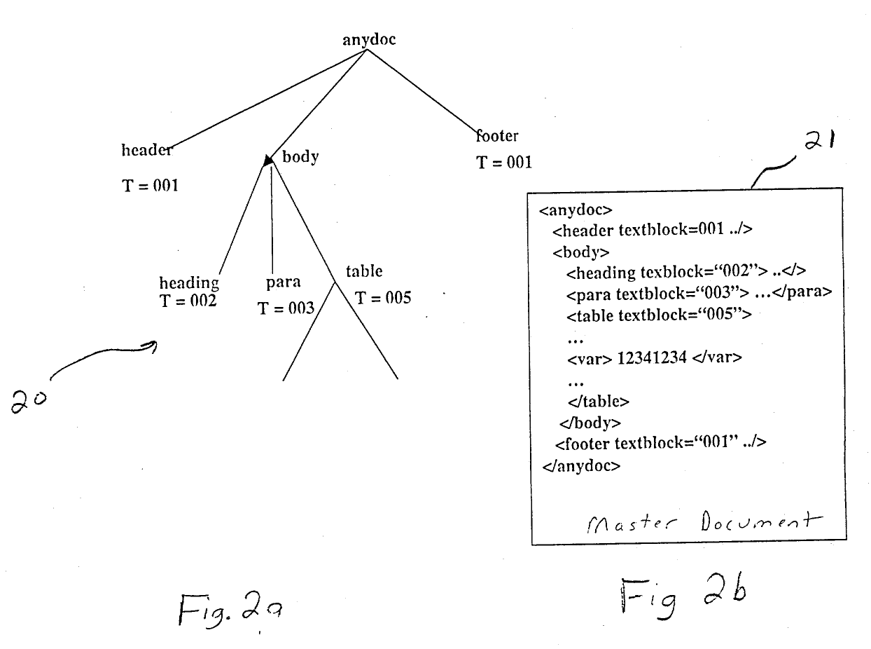

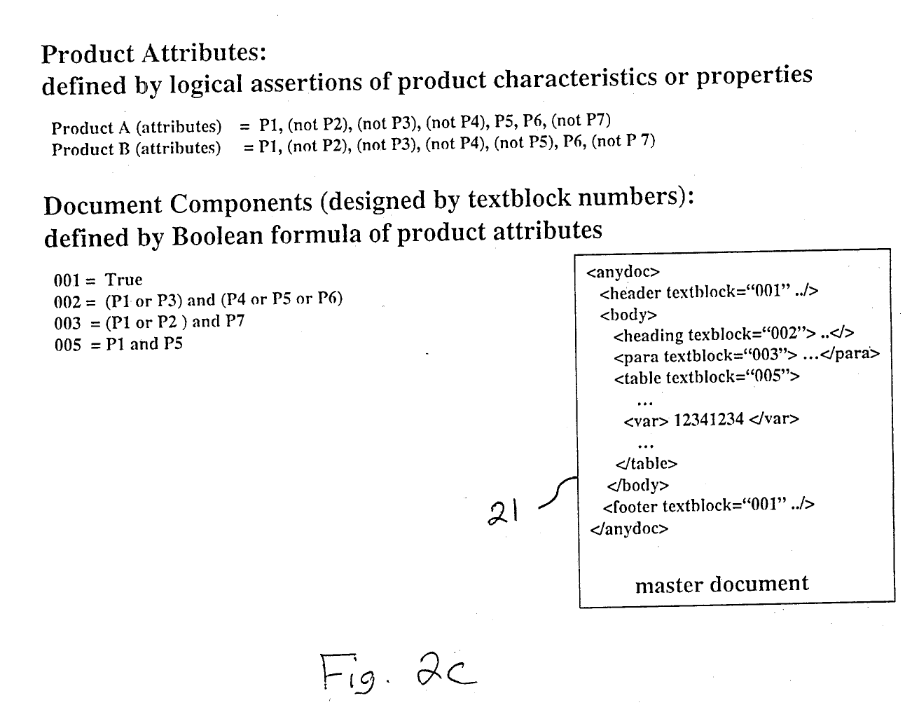

The component-based master documents comprise documents corresponding to a family of related machines/devices enriched with component numbers (or textblock numbers). As explained below, the component numbers are used for selecting components of the master document during a profiling process. An exemplary master document is depicted in FIGS. 2a and 2b and will be described in more detail below.

The product attributes are used to define specific products and comprise logic assertions of physical characteristics of products and their components. As explained below, the attributes are used to collect relevant components of the master document for creating specific document profiles. The component definitions define document components and comprise Boolean formulas of product properties (attributes). The component definitions are used for associating document content with product characteristics. Exemplary specifications for product attributes and document components are depicted in FIG. 2c and will be described in more detail below.

The product-specific KKS numbers comprise identification numbers for components, etc, of specific products to be documented.

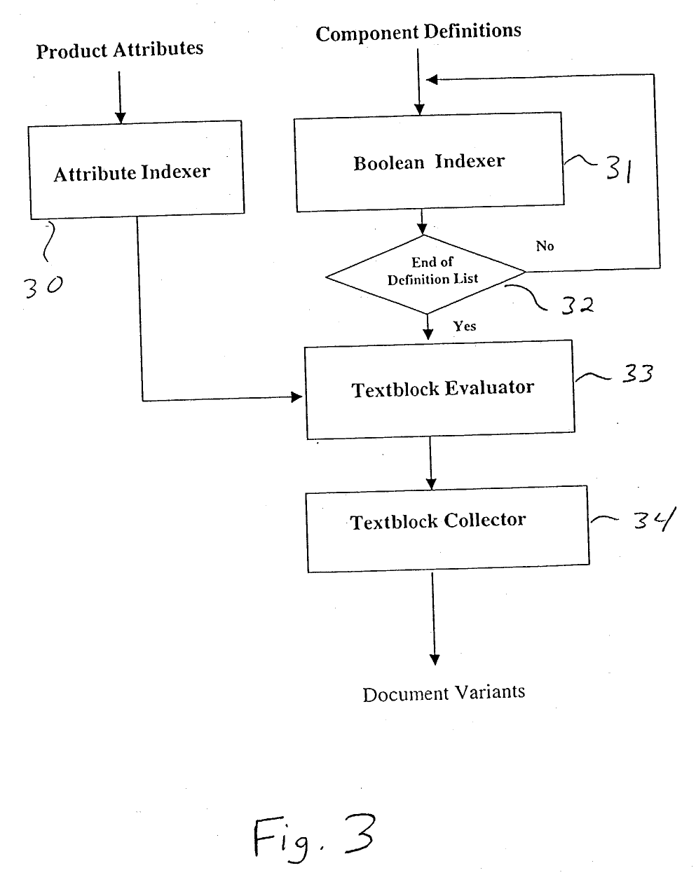

In the exemplary embodiment of FIG. 1, the product document profiling module (11) comprises a variant calculator module (12) and a document selector module (13). The variant calculator module (12) receives as input the product attributes and component definitions and generates an intermediate result, document variants, which are input to the document selector module (13). A document variant is defined herein as a set of document components of a master document, which are associated with a specific product. One preferred mode of operation of the variant calculator module (12) will be discussed below with reference to the flow diagram of FIG. 3.

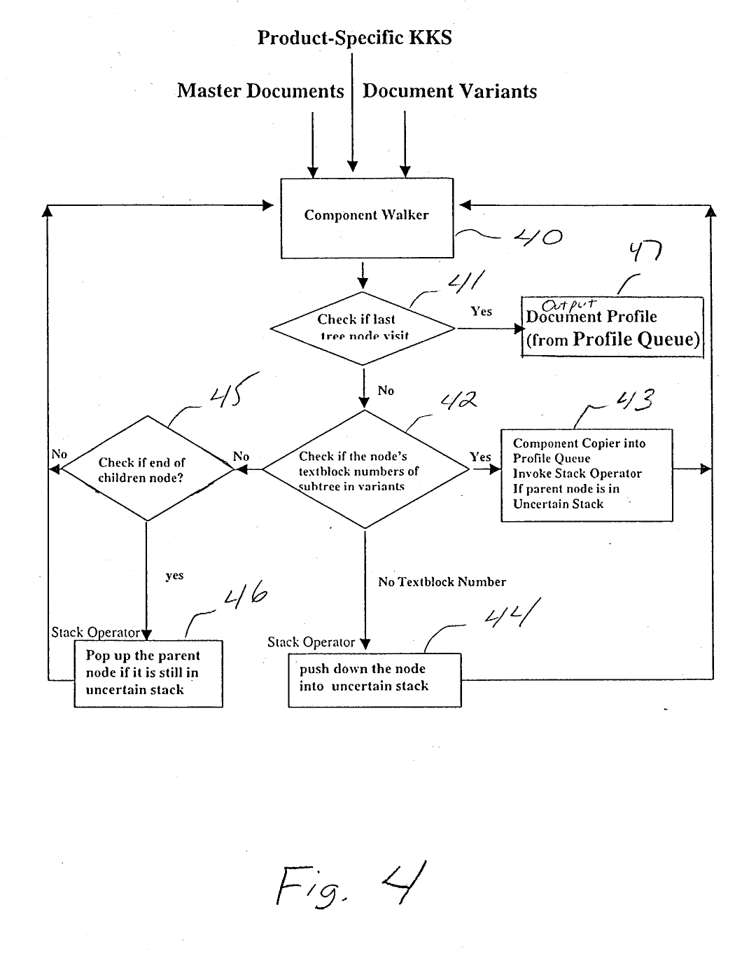

The document selector module (13) will create a document profile for a specific product by collecting all necessary document components from the component-based master document in accordance with the document variants and instantiating the product-specific KKS numbers. Accordingly, based on the document variants, component-based master documents, and machine-specific KKS numbers, the document selector module (13) will generate document profile comprising product-specific documents. A preferred mode of operation of the document selector module (13) will be discussed in more detail below with reference to the flow diagram of FIG. 4.

FIGS. 2a and 2b are exemplary diagrams illustrating a component-based master document according to one aspect of the invention, which is used to create product-specific documents. More specifically, FIG. 2a illustrates a tree-structure (20) of an exemplary master document and FIG. 2b illustrates a SGML/XML document instantiation (21) of the exemplary master document based on the tree-structure of FIG. 2a.

As noted above, the component-based master document (21) is used to create product-specific documents for a family of related products. Preferably, component-based master document in FIG. 2b is an SGML/XML-based document that comprises “textblock” numbers that identify components of the master documents. In addition, the master document comprises <var> tags that act as generic KKS number placeholders. Advantageously, a master document according to the invention is designed such that it can be readily determined which components (or document fragments) of the master documents are to be included in a product-specific document according to a given document variant.

In FIG. 2a, each node the master document tree (20) represents an element (or component) of the master document. The document components are represented by textblock numbers. More specifically, each node in the master document tree (20) has either an explicit or implicit textblock number associated with it. For instance, the <header> and <footer> components have an explicit textblock number T=001 associated therewith. The <body> component is made up of sub-components <heading>, <para> and <table>, which have explicit textblock numbers T=002, T=003 and T=005, respectively. The <body> component is considered as having an implicit textblock number, which indicates that the children nodes (subcomponents) of the <body> component (node) are used to determine if the <body> component is a master document fragment that will be included in a product specific-document.

More specifically, as noted above, a document variant is a set of component (or textblock) numbers in the master documents which are appropriate for a specific product. If an explicit textblock number of a given node is a member of a document variant, then the entire sub-tree rooted at the given node is deemed a part of document fragments for the profile by the variant. For example, if the text-block number T=005 is included in a document variant, then all sub-components (not shown) of the <table> component will be part of the corresponding document profile of specific product.

Furthermore, for a given node having an implicit textblock number, if any child node is a member of the document variant, then the given node is also a part of document fragment in the profile by the variant. For example, if one or more of the sub-components <heading>, <para> or <table> (child nodes) of the <body> component(parent node) is a member of a document variant, then the <body> component of the master document will be included in the corresponding product-specific document (and the <body> component will include the subcomponents specified in the document variant).

Referring now to FIG. 2c, an exemplary diagram illustrates logic specifications for product attributes for two exemplary products, ProductA and ProductB, and logic specifications for document components of the master document shown in FIG. 2b. The document component definitions and product attributes (which are input to the variant calculator module (12) in FIG. 1) provide relevant information regarding relationships between product attributes and document content. In a preferred embodiment of the invention, specific products are defined by one or more product attributes. The product attributes comprise logical assertions of product physical characteristics (e.g., numbers of pumps used in a turbine, types of liquid systems, etc.). Referring to FIG. 2c, by way of example, ProductA and ProductB are defined as:

Product A (attributes)=P1, (not P2), (not P3), (not P4), P5, P6, (not P7)

Product B (attributes)=P1, (not P2), (not P3), (not P4), (not P5, P6, (not P7).

Furthermore, the document component definitions preferably comprise Boolean formulas of product attributes. In other words, the component definitions comprise logical statements that associate document content with product characteristics. For instance, as continuing with the above example for ProductA and ProductB as shown in FIG. 2c, document components (as preferably designed by text block number) may be defined by the following Boolean formulas using the above product attributes as follows:

001=True

002=(P1 or P3) and (P4 or P5 or P6)

003=(P1 or P2) and P7

005=P1 and P5

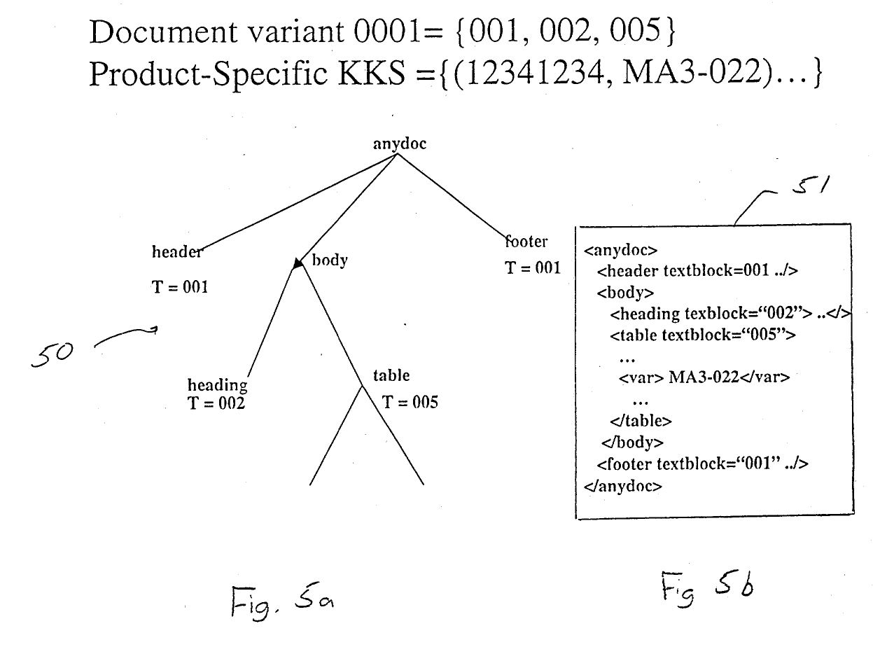

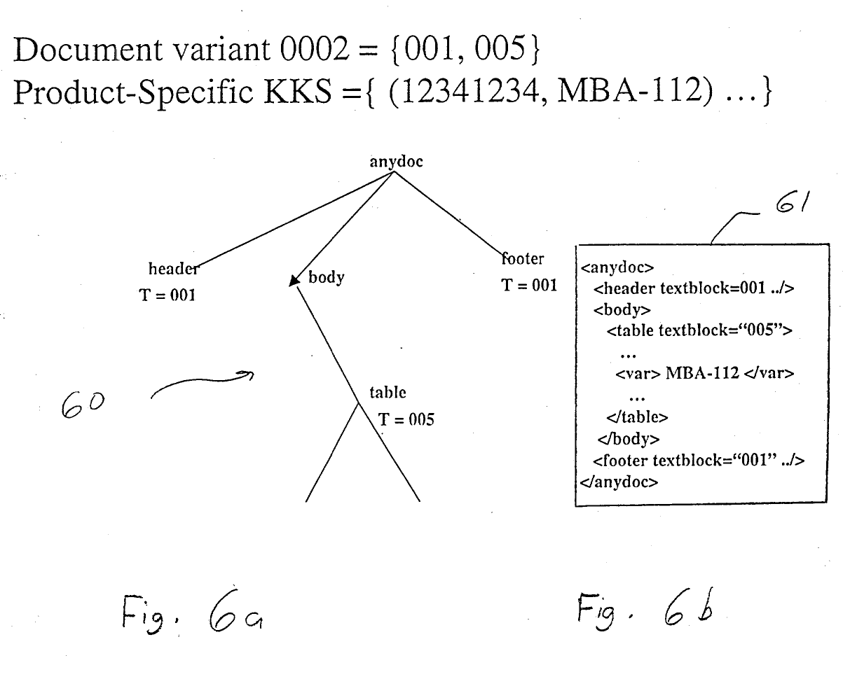

The document components (as specified by the textblock numbers, T) of a component-based master document will be included in a particular product document profile, if the Boolean statements for the document components are evaluated to be true. In the example of FIG. 2c, document component T=001 is specified as being “true”, meaning that the associated component will be included in all product-specific documents, regardless of the product attributes. Exemplary product-specific documents that are derived using the master document and specifications shown in FIGS. 2a, b and c will be described below with reference to FIGS. 5 and 6.

FIG. 3 is a flow diagram that illustrates a method for determining document variants according to one aspect of the invention. In particular, the flow diagram of FIG. 3 illustrates a mode of operation (as well as constituent modules) of the variant calculator module (12) of FIG. 1, according to an embodiment of the invention. As discussed above, the input to the variant calculator module (12) comprises product attributes and component definitions, which are evaluated to determine document variants. By way of example, the input component definitions and product attributes may be associated with specific documents of a product technical manual. Again, the document variant of a given product comprises a set of document components (designed by textblock numbers) appropriate for the product based on the product attributes of the product. Each document may have different variants (i.e., different components or textblock numbers) in the product documents.

Referring now to FIG. 3, the input product attributes are processed to create a hash index table for all the attributes (step 30). The component definitions are processed to create a hash index table for the Boolean formulas of each component definition (step 31). When the end of the definition list is reached (affirmative determination in step 32), a textblock evaluation process (step 33) is performed to efficiently evaluate the component definitions based on the given product attributes. The textblock evaluation process (step 33) will return either a “true” or “false” result for each component. A textblock collection process (step 34) collects the textblock numbers of those components having an evaluation result of “true” and places such components into a document variant. In other words, the resulting document variant will comprise a set of textblock numbers whose evaluation results are determined to be true.

FIG. 4 is a flow diagram that illustrates a method for document selection according to one aspect of the invention. In particular, the flow diagram of FIG. 4 illustrates a mode of operation (as well as constituent modules) of the document selector module (13) in FIG. 1, according to an embodiment of the invention. As discussed above, the input to the document selector module (13) comprises a component-based master document, document variants (generated by the method of FIG. 3) and product-specific KKS numbers. The document selector module (13) will instantiate the master document based on the document variants, and substitute the <var>'s generic KKS numbers with product-specific KKS numbers, to thereby generate document profiles (or product-specific documents) obtained from all necessary document components from the master documents. In other words, each document profile comprises an instance of the master document based on an associated document variant and product-specific KKS numbers.

In a preferred embodiment, the document selector module (13) of FIG. 1 comprises Component Walker module, a Component Copier module, and a Stack Operator module, as well as two shared data structures, referred to herein as “Uncertain Stack” and “Profile Queue”. More specifically, referring now to FIG. 4, a document selection process comprises a document walker process (step 40) wherein components of an input master document are visited in a tree depth-first order manner. If the last node of the master document has not been visited (negative determination in step 41), the textblock number of the current node is evaluated to determine if the textblock number of the node is included in the document variant (step 42). In other words, in step 42, a node (which is the root of a subtree) will be used to determine whether or not the node will be part of the document profile by using textblock numbers in the node's subtree. As discussed above, if an explicit textblock number of a given node is a member of the document variant, then the entire sub-tree rooted at the given node is deemed to be part of the document profile. For a given parent node having an implicit textblock number, if any child node is a member of the document variant, then the parent node is also deemed part of the document profile.

Accordingly, if it is determined that a node in the subtree has a textblock number that is included in the document variant (affirmative determination in step 42), then a component copier process (step 43) is performed to copy the current node (and its subtree, if any) into the profile queue and instantiate the <var> content with the product specific KK numbers. In such a case, if the current node (with an explicit textblock number) is a child node, and if the parent node is in the uncertain stack during copying of the child node, the component copier process (step 43) will also call the stack operator to pop up the parent node of the subtree root and copy the parent into the profile queue.

If it can not be determined whether or not a node in the subtree is included in the document variant (uncertain determination in step 42), the stack operator is called to perform a stack operation to push down the current node into an “uncertain” stack (step 44), and the process returns to the component walker process to visit the next node (step 40).

If it is determined that the textblock numbers of the subtree of the current node are not included in the document variants (negative determination in step 42), then a determination is made as to whether the node is the end of the subtree (step 45). If the node is the end of the subtree (affirmative determination in step 45), then the status of the parent node is determined. More specifically, a stack operation is performed to pop up the parent node if such node is still in the uncertain stack (step 46). A determination is made as to whether the parent node is in the product profile if any child node is known not to be in the product profile due to the end of the children node (step 45) and not in the variants (step 42). The process then returns to the component walker process (step 40).

Therefore, the uncertain stack stores undetermined tree nodes in a stack manner. The profile queue stores document nodes whose textblock numbers are members of the document variant. The stack Operator is used to pop up or push down nodes into the uncertain stack under different circumstances. For example, the component copier will call the stack operator to pop up the parent node of the subtree root and copy it into the profile queue if the parent node is in the uncertain stack during copying any children nodes.

Once the last tree node has been visited (affirmative determination in step 41), the document profile is output from the profile queue.

FIGS. 5a and 5b are an exemplary diagrams illustrating a document profile for ProductA derived from the master document of FIG. 2b using the exemplary specifications and the master document components shown in FIG. 2c. In particular, FIG. 5a illustrates a tree-structure (50) of the exemplary document profile for ProductA and FIG. 5b illustrates an SGML/XML instantiation (51) of the document profile for Product a based on the tree structure of FIG. 5a.

The exemplary document profile (51) of FIG. 5b is generated using a document selection process (FIG. 4) with a document variant 0001={001,002,005}, product specific KKS={(12341234,MA3-22) . . . } and the master document (21) of FIG. 2b, as inputs to the document selection process. The document variant 0001={001,002,005} is generated (FIG. 3) based on the exemplary product attributes (for ProductA) and component definitions shown in FIG. 2c. The document profile (51) in FIG. 5b comprises an instance of the master document (21 (FIG. 2b) and includes document components of the master document having text block numbers 001, 002 and 005. As shown in FIG. 5, the structure of the document profile is similar to the structure of the master document, except that the <body> element of the document profile does not include the <para> subelement (i.e., the component 003 is omitted by virtue of the Boolean equation for textblock T=003 in the example of FIG. 2c). In addition, the produce-specific KKS number as shown inserted between the <var> markup tags.

FIGS. 6a and 6b are an exemplary diagrams illustrating a document profile for ProductB derived from the master document of FIG. 2b using the exemplary specifications and the master document components shown in FIG. 2c. In particular, FIG. 6a illustrates a tree-structure (60) of the exemplary document profile for ProductB and FIG. 6b illustrates an SGML/XML instantiation (61) of the document profile for ProductB based on the tree structure of FIG. 6a.

The exemplary document profile (61) of FIG. 6b is generated using a document selection process (FIG. 4) with a document variant 0002={001,005}, product-specific KKS={(12341234, MBA-112) . . . }, and the master document (21) of FIG. 2b, as inputs to the document selection process. The document variant 0001={001,005} is generated (FIG. 3) based on the exemplary product attributes (for ProductB) and component definitions shown in FIG. 2c. The document profile (61) in FIG. 6b comprises an instance of the master document (21) (FIG. 2b) and Includes the document components of the master document having text block numbers 001 and 005. As shown in FIG. 6, the structure of the document profile is similar to the structure of the master document, except that the <body> element of the document profile does not include the <para> subelement and the <heading> subelement (i.e., the components 002 and 003 are omitted by virtue of the Boolean equation for textblocks T=002 and T=003 in the example of FIG. 2c). In addition, the produce-specific KKS number MBA-112 is shown as inserted between the <var> markup tags.

Although illustrative embodiments have been described herein with reference to the accompanying drawings, it is to be understood that the invention is not limited to the precise system and method embodiments described herein, and that various other changes and modifications may be affected therein by one skilled in the art without departing form the scope or spirit of the invention. All such changes and modifications are intended to be included within the scope of the invention as defined by the appended claims.

What is claimed is:

1. A method for processing electronic documents, comprising the steps of:
generating a master document having a plurality of components;
generating a product specification for a specific product, wherein the product specification is defined by one or more product attributes;
generating component definitions for components of the master document, wherein components of the master document are defined based on the product attributes; and
automatically generating a document profile for the specific product using components of the master document based on the component definitions and the product specification.

2. The method of claim 1, wherein the master document is authored using SGML (standard generalized markup language) or an extension thereof and wherein the document profile comprises a document instance of the master document.

3. The method of claim 1, wherein the step of automatically generating a document profile comprises:
evaluating the product attributes and the component definitions to generate an intermediate result comprising a set of components from the master document that are associated with the specific product; and
selecting components of the master document based on the intermediate result to create the document profile for the specific product.

4. The method of claim 3, wherein components of the master document are identified by unique component numbers, wherein the component definitions for the components of the master document are defined by Boolean formulas of the product attributes, and wherein the step of evaluating comprises evaluating the Boolean formulas of the component definitions to determine which component numbers of the master document are associated with the specific product.

5. The method of claim 4, wherein the step of selecting components of the master document comprises parsing a tree-structure of the master document having nodes that are associated with the component numbers.

6. The method of claim 1, comprising the step of specifying a product specific identification number for the specific product, and wherein the step of automatically generating a document profile for the specific product further comprises including the product specific identification number in the document profile.

7. The method of claim 6, wherein the product-specific number comprises a KKS number.

8. A program storage device readable by machine, tangibly embodying a program of instructions executable by the machine to perform method steps for processing electronic documents, the method steps comprising:
receiving as input, a master document having a plurality of components, a product specification for a specific product, wherein the product specification is defined by one or more product attributes, and component definitions for components of the master document, wherein components of the master document are defined based on the product attributes; and
automatically generating a document profile for the specific product using components of the master document in accordance with the component definitions and the product specification.

9. The program storage device of claim 8, wherein the master document is authored using SGML (standard generalized markup language) or XML (an extensive markup language) and wherein the document profile comprises a document instance of the master document.

10. The program storage device of claim 8, wherein the instructions for automatically generating a document profile comprise instructions for:
evaluating the product attributes and the component definitions to generate an intermediate result comprising a set of components from the master document that are associated with the specific product; and
selecting components of the master document based on the intermediate result to create the document profile for the specific product.

11. The program storage device of claim 10, wherein components of the master document are identified by unique component numbers, wherein the component definitions for the components of the master document are defined by Boolean formulas of the product attributes, and wherein the instructions for evaluating comprise instructions for evaluating the Boolean formulas of the component definitions to determine which component numbers of the master document are associated with the specific product.

12. The program storage device of claim 11, wherein the instructions for selecting components of the master document comprise instructions for parsing a tree-structure of the master document having nodes that are associated with the component numbers.

13. The program storage device of claim 8, comprising instructions for receiving as input, a product specific identification number for the specific product, and wherein the instructions for automatically generating a document profile for the specific product comprise instructions for including the product specific identification number in the document profile.

14. The program storage device of claim 13, wherein the product-specific number comprises a KKS number.

15. A product document profiling system for automatically generating product-specific documents from a master document, the system comprising:
a document variant calculator module for processing product specifications for specific products and component definitions for components of a master document to generate document variants for the specific products, wherein each document variant comprises a set of component identifiers that identify components of the master document which are associated with a given specific product; and
a document selector module that processes the master document and the document variants to automatically generate a plurality of document instances of the master document, wherein each document instance comprises a unique document profile for a specific product.

16. The system of claim 15, wherein the product specifications comprise logical assertions of product attributes of the specific products, and wherein components of the master document are defined by Boolean formulations of the product attributes.

17. The system of claim 15, wherein the component identifiers comprise textblock numbers.

18. The system of claim 15, wherein the master document and document profiles are based on SGML (standard generalized markup language) or XML (an extensive markup language).

19. The system of claim 15, wherein the document selector module processes product specific identification numbers for the specific products and instantiates the product specific identification numbers in the document profiles.

20. The system of claim 19, wherein the product-specific numbers comprise KKS numbers.
